(19) United States
(12) Patent Application Publication
(10) Pub. No.: US 2014/0176722 A1
(43) Pub. Date: Jun. 26, 2014

(54) IMAGING DEVICE, IMAGING CONTROL METHOD AND STORAGE MEDIUM

(71) Applicant: CASIO COMPUTER CO., LTD., Tokyo (JP)

(72) Inventor: Kenzo SASHIDA, Tokyo (JP)

(73) Assignee: CASIO COMPUTER CO., LTD., Tokyo (JP)

(21) Appl. No.: 14/073,364

(22) Filed: Nov. 6, 2013

(30) Foreign Application Priority Data
Dec. 25, 2012 (JP) 2012-281116

(51) Int. Cl. H04N 5/232

(52) U.S. Cl. CPC H04N 5/23296
USPC 348/158

(57) ABSTRACT

An imaging device includes an imaging section which includes a lens block and an image sensor, and a CPU which judges whether or not an image captured by the imaging section satisfies a predetermined composition condition (a luminance distribution; sky:ground=7:3) and, based on the judging result, drives the imaging section by using a motor so that the image captured by the imaging section satisfies the predetermined composition condition to adjust the composition of the image captured by the imaging section.

### CROSS-REFERENCE TO RELATED APPLICATION

This application is based upon and claims the benefit of priority from the prior Japanese Patent Application No. 2012-281116, filed Dec. 25, 2012, the entire contents of which are incorporated herein by reference.

### BACKGROUND OF THE INVENTION

1. Field of the Invention

The present invention relates to an imaging device, imaging control method and storage medium.

2. Description of the Related Art

Conventionally, head-mount type imaging devices to be mounted on the user's head have been suggested. In the head-mount-type imaging device, since an image at an angle of view in an eye-gaze direction is captured without requiring the user to hold the imaging device by hand at the ready, image capturing can be performed without missing a perfect shot. Also, the head-mount-type imaging device allows both hands to freely move even in a situation where the user moves his or her body, and therefore can be very effectively used in sports, trekking, mountain climbing, running, etc.

For example, for the head-mount-type imaging device, Japanese Patent Application Laid-Open (Kokai) Publication No. 2003-046838 discloses a technology for matching the eye-gaze direction of a user with the direction of a subject. This publication also discloses a technology in which a light with high straight-traveling property is projected onto a subject from a head-mount-type imaging device as initialization processing, whereby whether or not the eye-gaze direction of the user is matched with the direction of the subject is checked for adjustment.

### SUMMARY OF THE INVENTION

An object of the present invention is to provide an imaging device, imaging control method and storage medium capable of obtaining a captured image in a designed composition.

In accordance with a first aspect of the present invention, there is provided an imaging device comprising: an imaging section; a judging section which judges whether or not an image captured by the imaging section satisfies a predetermined composition condition; and a control section which controls an imaging composition of the imaging section so that the captured image satisfies the predetermined composition condition based on the judging result of the judging section.

In accordance with a second aspect of the present invention, there is provided an imaging control method comprising: a step of judging whether or not an image captured by an imaging section satisfies a predetermined composition condition; and a step of changing an imaging composition of the imaging section so that the captured image satisfies the predetermined composition condition based on the judging result.

In accordance with a second aspect of the present invention, there is provided a non-transitory computer-readable storage medium having stored thereon a program that is executable by a computer, the program being executable by the computer to perform functions comprising: judging processing for judging whether or not an image captured by an imaging section satisfies a predetermined composition condition; and controlling processing for changing an imaging composition of the imaging section so that the captured image satisfies the predetermined composition condition based on the judging result.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram of the structure of an imaging device 1 according to an embodiment of the present invention;

FIG. 2 is a perspective view of the outer appearance of the imaging device 1 according to the present embodiment;

FIG. 3 is a flowchart for describing the operation (correction processing) of the imaging device 1 according to the present embodiment;

FIG. 4A is a diagram depicting a walking motion of a user having the imaging device 1 according to the present embodiment mounted thereon, at a flat point;

FIG. 4B is a diagram depicting an image captured by the user having the imaging device 1 according to the present embodiment mounted thereon, at the flat point;

FIG. 5A is a diagram depicting a walking motion of the user having the imaging device 1 according to the present embodiment mounted thereon, at an uphill point without correction;

FIG. 5B is a diagram depicting an image captured by the user having the imaging device 1 according to the present embodiment mounted thereon, at an uphill point without correction;

FIG. 6A is a diagram depicting a walking motion of the user having the imaging device 1 according to the present embodiment mounted thereon, at an uphill point with correction;

FIG. 6B is a diagram depicting an image captured by the user having the imaging device 1 according to the present embodiment mounted thereon, at the uphill point with correction;

FIG. 7A is a diagram depicting a walking motion of the user having the imaging device 1 according to the present embodiment mounted thereon at the uphill point with further correction;

FIG. 7B is a diagram depicting an image captured by the user having the imaging device 1 according to the present embodiment mounted thereon, at the uphill point with further correction; and

FIG. 8 is a conceptual diagram for describing a judgment as to a ratio between a sky image area S and a ground image area G by the imaging device 1 according to the present embodiment.

### DETAILED DESCRIPTION OF THE PREFERRED EMBODIMENTS

An embodiment of the present invention is described below with reference to the drawings.

### A. Structure of Embodiment

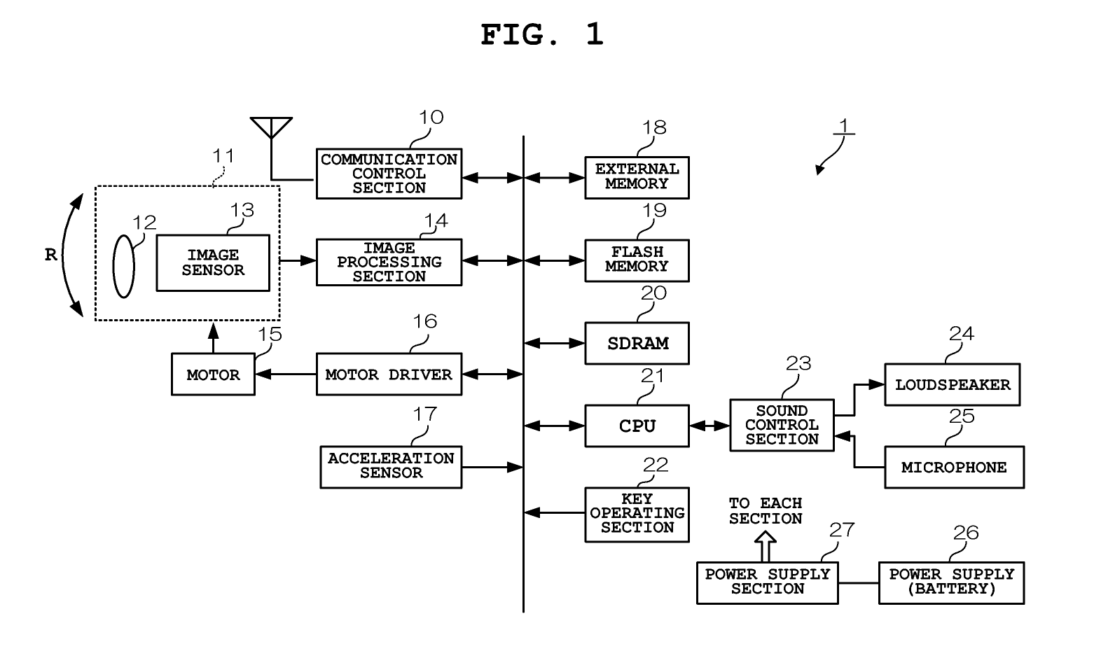

FIG. 1 is a block diagram of the structure of a head-mount-type imaging device 1 according to an embodiment of the present invention. In FIG. 1, the head-mount-type imaging device 1 includes a communication control section 10, an imaging section 11, an image processing section 14, a motor 15, a motor driver 16, an acceleration sensor 17, an external memory 18, a flash memory 19, an SDRAM (Synchronous Dynamic Random Access Memory) 20, a CPU (Central Processing Unit) 21, a key operating section 22, a sound control section 23, a loudspeaker 24, a microphone 25, a power supply (battery) 26, and a power supply control section 27.

The communication control section 10 transfers captured image data to a server on the Internet or an information processing device or the like such as a private personal computer via the Internet. The image data can be transferred also to an information device carried by a user via peer-to-peer communications. The imaging section 11 includes a lens block 12 formed of an optical lens group and an image sensor 13 such as a CCD (Charge Coupled Device) or a CMOS (Complementary Metal Oxide Semiconductor). The image sensor 13 converts an image entering from the lens block 12 to a digital signal. The image processing section 14 performs image processing (such as pixel interpolation processing, γ correction, luminosity color difference signal generation, white balance processing, or exposure correction processing), and compression and extension of image data (for example, compression and extension in a JPEG (Joint Photographic Experts Group) format or in a Motion-JPEG format or in a MPEG (Moving Picture Experts Group) format).

The motor 15 drives the imaging section 11 in a direction along a vertical plane which includes an optical axis (in an up and down direction: an angular direction indicated by R in FIG. 1) by following the control of the CPU 21, and thereby changes a capturing direction (also referred to as an optical axis direction) of the imaging section 11. The motor driver 16 drives the motor 15 by following the control of the CPU 21. The acceleration sensor 17 detects the movement of the head-mount-type imaging device 1 in conjunction with the movement of the head of the user (an elevation/depression angle direction ED: an up and down direction with a horizontal axis taken as a rotation axis, and also referred to as an eye-gaze direction of the user having the imaging device 1 mounted thereon). The external memory 18 is a removable storage medium, and stores image data captured by the imaging section 11. The flash memory 19 is a storage medium which stores image data captured by the imaging section 11. The SDRAM 20 is used as a buffer memory which temporarily stores image data captured by the imaging section 11 and then sent to the CPU 21 and also as a working memory for the CPU 21.

The CPU 21 is a one-chip microcomputer for controlling each section of the head-mount-type imaging device 1, and causes, for example, capturing a still image by the imaging section 11, starting/stopping recording of moving images, and switching between still image capturing and moving image capturing. In particular, in the present embodiment, the CPU 21 calculates, from the detection result of the acceleration sensor 17, a movement amount (an angle) of the head-mount-type imaging device 1 in the elevation/depression angle direction in conjunction with the movement of the head of the user in the elevation/depression angle direction. As described above, when the user wears the head-mount-type imaging device 1 on his or her head to record travels of mountain climbing, hiking, or the like, the user tends to turn his or her head upward or downward at a non-flat place (such as a slope), and therefore an image with only a sky image area S (or a ground image area G) or an image with a high ratio of the sky image area S (or the ground image area G) is captured. Based on the movement amount (angle) of the head-mount-type imaging device 1 in the elevation/depression angle direction obtained from the acceleration sensor 17, the CPU 21 drives the imaging section 11 by the motor 15 so that the imaging section 11 is oriented to a horizontal direction and, furthermore, a captured image in a composition with a desired luminance distribution can be obtained. As such, in the present embodiment, by performing drive control so that the imaging section 11 is oriented to the horizontal direction in conjunction with the movement of the head of the user in the elevation/depression angle direction and, furthermore, a captured image in a composition with the desired luminance distribution can be obtained, it can be avoided to capture an image with only the sky image area S (or the ground image area G) or an image with a high ratio of the sky image area S (or the ground image area G) because the user has turned his or her head upward or downward.

Following the control of the CPU 21, the sound control section 23 converts sounds (such as alarm sound) at the time of replaying the captured moving images to analog signals for output from the loudspeaker 24, and also digitalizes and captures environmental sounds collected by the microphone 25 at the time of capturing the moving images. The key operating section 22 inputs an operation mode or an operation instruction such as start capturing, pause, or stop, according to a touch operation of the user. The power supply (battery) 26 is a chargeable secondary battery. The power supply control section 27 stabilizes output voltage of the power supply (battery) 26 and causes driving power to be supplied to each section.

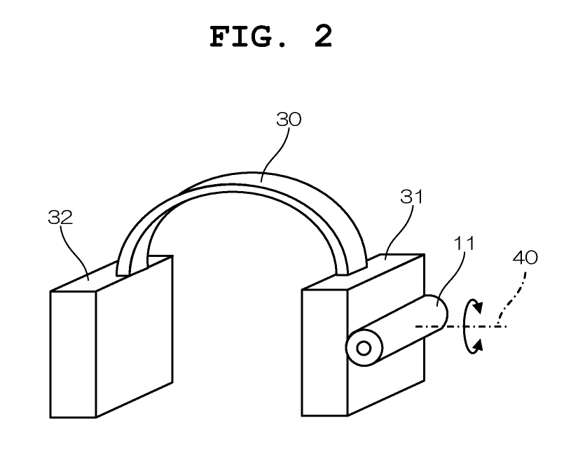

FIG. 2 is a perspective view of the outer appearance of the head-mount-type imaging device 1 according to the present embodiment. In FIG. 2, the head-mount-type imaging device 1 is constituted by a head band 30, a housing 31, a housing 3 and the imaging section 11. The user wears the imaging device 1 as if he or she wears a headphone so that the housing 31 and the housing 32 cover the ears across the head. The imaging section 11 and the housing 31 are connected via one shaft in the horizontal direction so that the orientation (capturing direction) of the imaging section 11 can be rotated in the elevation/depression angle direction about a rotation axis 40 with respect to the housing 31. The imaging section 11 is rotated by the motor 15 incorporated in the housing 31.

### B. Operation of Embodiment

Next, the operation of the above-described embodiment is described.

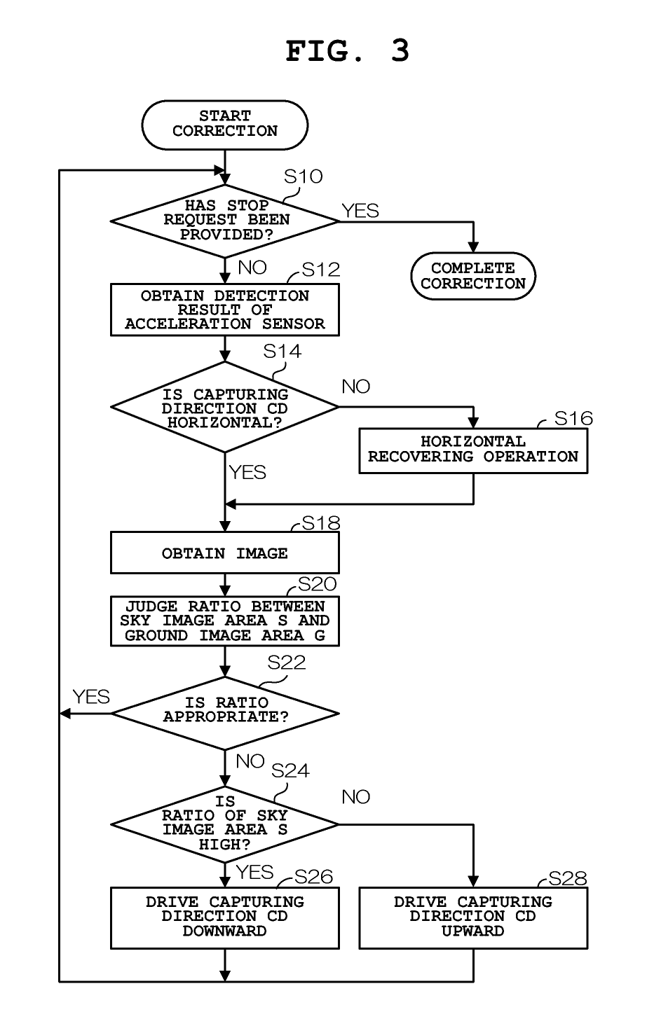

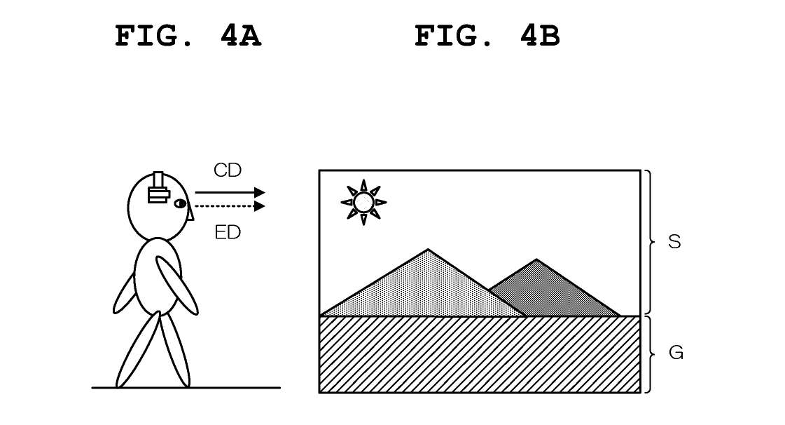

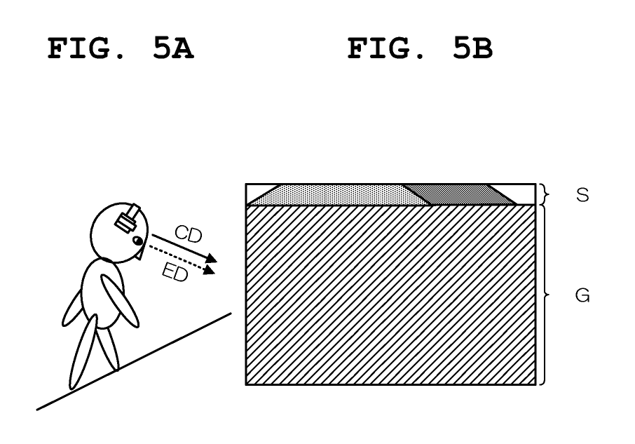

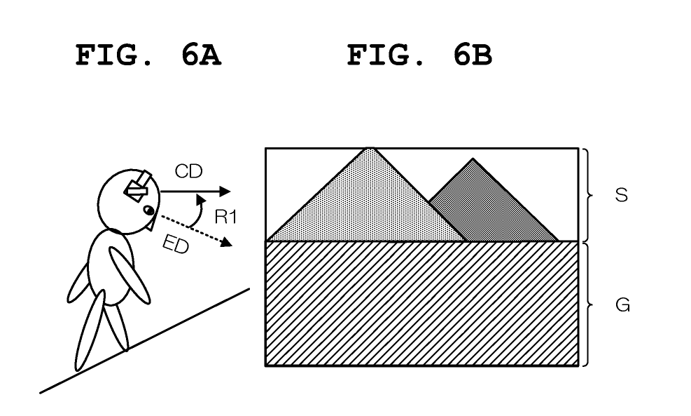

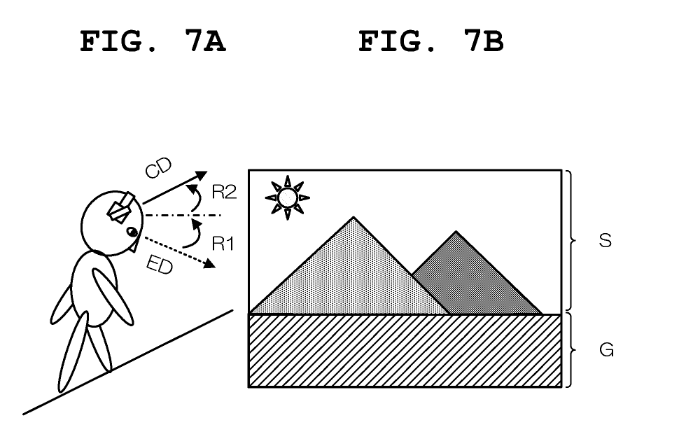

FIG. 3 is a flowchart for describing the operation (correction processing) of the head-mount-type imaging device 1 according to the present embodiment. FIG. 4A, FIG. 4B, FIG. 5A, FIG. 5B, FIG. 6A, FIG. 6B, FIG. 7A and FIG. 7B are schematic views depicting the head-mount-type imaging device and a captured image according to the present embodiment. In the following, the operation of capturing a moving image by the imaging section 11 is well known and is therefore explanations thereof are omitted, and only correction processing of correcting the capturing direction of the imaging section 11 is described.

First, after setting correction of a capturing direction CD as effective, the user wears the head-mount-type imaging device 1 on his or her head, and operates the key operating section 22 to start capturing. Upon the start of capturing, a correction processing routine depicted in FIG. 3 is repeatedly performed at predetermined time intervals. In the correction processing, the CPU 21 first judges whether or not a correction processing stop request has been provided (Step S10).

If a correction processing stop request has been provided by a user operation (YES at Step S10), the processing is completed.

On the other hand, if a correction processing stop request has not been provided (NO at Step S10), the CPU 21 obtains the detection result of the acceleration sensor 17 (Step S12). Next, from the detection result of the acceleration sensor 17, the CPU 21 judges whether or not the capturing direction CD of the head-mount-type imaging device 1 is horizontal (Step S14). For example, as depicted in FIG. 4A, when the user is walking a flat place, the capturing direction CD of the head-mount-type imaging device 1 is horizontal in conjunction with the orientation (eye-gaze direction) ED of the head of the user. Here, the captured image has an appropriate angle-of-view ratio between the sky image area S and the ground image area G (for example, sky:ground=7:3) as depicted in FIG. 4B.

On the other hand, as depicted in FIG. 5A, when the user is walking a non-flat place (a slope, in particular, uphill) on mountain climbing, hiking, or the like, there is a high possibility that that the slope (ground) comes the eye-gaze front. Additionally, since the user consciously picks his or her steps, his or her eye-gaze direction ED is often oriented downward. As a result, the capturing direction CD of the head-mount-type imaging device 1 is not horizontal in conjunction with the eye-gaze direction ED. At this time, the captured image has an inappropriate angle-of-view ratio between the sky image area S and the ground image area G (for example, sky:ground−1:7) as depicted in FIG. 5B.

As such, when the capturing direction CD of the head-mount-type imaging device 1 is not horizontal as depicted in FIG. 5A (NO at Step S14), the CPU 21 drives the motor 15 via the motor driver 16 and performs a horizontal recovering operation by so that the capturing direction CD of the imaging section 11 is horizontal (Step S16). On the other hand, when the capturing direction CD of the head-mount-type imaging device 1 is horizontal as depicted in FIG. 4A (YES at Step S14) or becomes horizontal after the horizontal recovering operation is performed, the CPU 21 obtains an image by capturing (Step S18) and judges a ratio between the sky image area S and the ground image area G in the obtained image (Step S20) Various way of identifying the sky image area S and the ground image area G can be thought. In the present embodiment, this identification is performed based on a luminance distribution of the captured image, which will be described further below in detail.

Next, the CPU 21 judges whether or not the ratio between the sky image area S and the ground image area G in the captured image is appropriate (Step S22). In the present embodiment, the ratio between the sky image area S and the ground image area G is set to 7:3, as an example. However, the ratio may be settable as appropriate. When the ratio between the sky image area S and the ground image area G in the captured image is appropriate (YES at Step S22), the CPU 21 returns to Step S10, and repeats the above-described processing.

As described above, when the user is walking a slope (in particular, uphill), the head-mount-type imaging device 1 is oriented downward. In this case, as depicted in FIG. 6A, the CPU 21 performs a horizontal recovering operation by driving the motor 15 and rotating the imaging section 11 by R1 so that the capturing direction CD of the imaging section 11 becomes horizontal. However, the ratio between sky image area S and the ground image area G may have an inappropriate value as depicted in FIG. 6B if the capturing direction CD is merely recovered to be horizontal. Thus, when the ratio between the sky image area S and the ground image area G in the captured image is inappropriate (NO at Step S22), the CPU 21 judges whether or not the ratio of the sky image area S is high (Step S24). Although not shown, when the ratio of the sky image area S is high (YES at Step S24), which means that the capturing direction CD of the imaging section 11 is oriented too upward, the CPU 21 drives the motor 15 via the motor driver 16 to cause the capturing direction of the imaging section 11 to be oriented downward by a predetermined amount (a predetermined angle) R2 (Step S26). The CPU 21 then returns to Step S10 and repeats the above-described processing.

On the other hand, as depicted in FIG. 6B, when the ratio of the ground image area G is high while the capturing direction CD of the imaging section 11 is recovered to be horizontal (ND at Step S24), which means that the capturing direction CD of the imaging section 11 is oriented too downward, the CPU 21 drives the motor 15 via the motor driver 16 to cause the capturing direction CD of the imaging section 11 to be oriented further upward by the predetermined amount (predetermined angle) R2 (Step S28). As a result, the ratio between the sky image area S and the ground image area G becomes appropriate (7:3) as depicted in FIG. 7B. The CPU 21 then returns to Step S10 and repeats the above-described processing. (Note that R2 at Step S26 and R2 at Step S28 do not necessarily mean the same angle.)

The predetermined amount (predetermined angle) R2 is a difference between the amount (angle) in the ratio between the sky image area S and the ground image area G before becoming appropriate and the amount (angle) in the appropriate ratio (7:3), which will be described further below in detail. Accordingly, by driving the capturing direction CD of the imaging section 11 by the predetermined amount (predetermined angle) R2 representing the difference in the elevation/depression angle direction, the ratio between the sky image area S and the ground image area G in the captured image becomes appropriate (7:3).

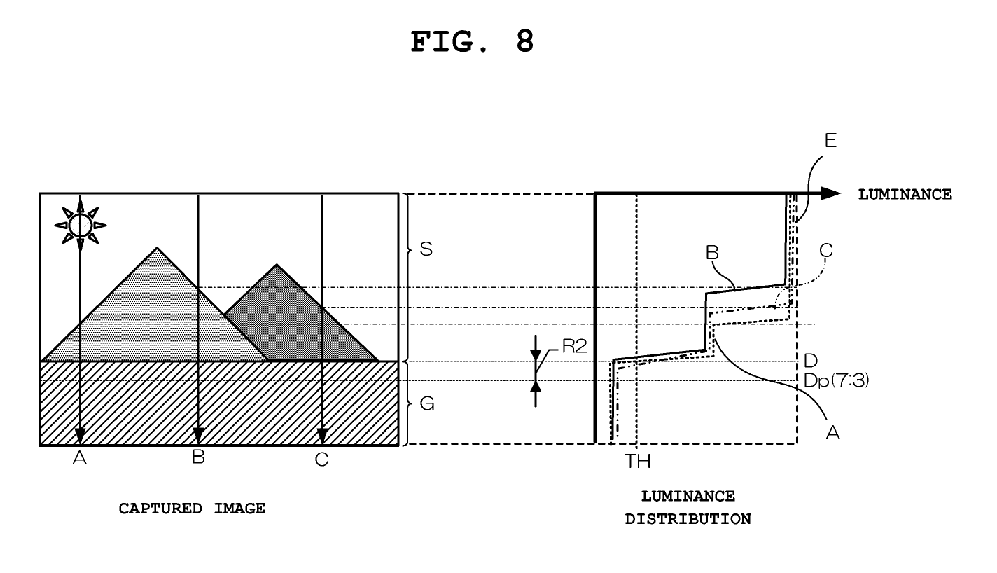

FIG. 8 is a conceptual diagram for describing a judgment as to a ratio between the sky image, area S and the ground image area G by the head-mount-type imaging device 1 according to the present embodiment. In FIG. 8, a captured image is depicted on the left side, and a luminance distribution at positions A, B, and C of the captured image is depicted on the right side. In the present embodiment, as described above, the ratio between the sky image area S and the ground image area G is judged based on the luminance distribution of the captured image. The CPU 21 obtains luminance data of the captured image, scans the luminance of the captured image in the longitudinal direction including each of A, B, C, and obtains the luminance distribution depicted on the right side of FIG. 8.

Generally speaking, a sky image tends to be relatively bright and a ground image tends to be relatively dark. Accordingly, a luminance value for identifying a boundary between the sky image area S and the ground image area G statistically obtained from many cases is set as a threshold TH. The CPU 21 calculates a boundary position D between the sky image area S and the ground image area G from an average of positions where a luminance at any of A, B, and C is below the threshold TH. A difference between the boundary position D and an appropriate value Dp is the predetermined amount (predetermined angle) R2. The CPU 21 then judges that the ratio is appropriate when the boundary position P obtained from the ratio between the sky image area S and the ground image area G is equal to the appropriate value Dp for example, 7:3), and otherwise judges that the ratio is inappropriate. The CPU 21 then drives the motor 15 according to the difference R2 (that is, the predetermined amount (predetermined angle) between the boundary position P and the appropriate value Dp (that is, predetermined amount (predetermined angle)) to correct the capturing direction CD of the imaging section 11. Here, E is maximum luminance.

In the above-described embodiment, the capturing angle of view is adjusted by driving the imaging section 11 with the motor 15. However, the present invention is not limited thereto. Alternatively, an image may be captured at a maximum wide angle in advance and the size and trimming position of the captured image may be then changed to obtain an image in a desired composition.

Furthermore, adjusting the capturing angle of view by driving the motor 15 (rough adjustment) and changing the size and trimming position of the captured image (fine adjustment) may both be used.

According to the above-described embodiment, in the head-mount-type imaging device 1, the capturing direction CD of the imaging section 11 is adjusted as required, even if the eye-gaze direction ED of the user is changed upward or downward and the imaging composition is changed, whereby a predetermined composition condition (luminance distribution) is not satisfied. Accordingly, even if the eye-gaze direction ED of the user is inappropriate, a captured image in a desired composition can be obtained.

Also, according to the above-described embodiment, in the head-mount-type imaging device 1, the movement of the imaging device 1 is detected as required, and the capturing direction CD of the imaging section 11 is corrected according to the movement, even if the eye-gaze direction ED of the user is changed upward or downward, and the imaging composition is changed, whereby a predetermined composition condition (luminance distribution) is not satisfied. Accordingly, even if the eye-gaze direction of the user is inappropriate, a captured image in a desired composition can be obtained. For this reason, even if the user is walking a slope uphill or downhill (for example, in mountain climbing), it can be avoided to capture an image with only the sky or with a high ratio of the sky or an image with only the ground or with a high ratio of the ground.

Furthermore, according to the above-described embodiment in the head-mount-type imaging device 1, the size and trimming position of the image captured at a wide angle are changed as required, even if the eye-gaze direction ED of the user is changed upward or downward, and the imaging composition is changed, whereby a predetermined composition condition (luminance distribution) is not satisfied. Accordingly, even if the eye-gaze direction of the user is inappropriate, a captured image in a desired composition can be obtained.

Still further, according to the above-described embodiment, whether or not the captured image satisfies a predetermined composition condition is judged based on the luminance distribution of the captured image. Accordingly, a judgment can be easily made with simple image processing.

While the present invention has been described with reference to the preferred embodiments, it is intended that the invention be not limited by any of the details of the description therein but includes all the embodiments which fall within the scope of the appended claims.

What is claimed is:

1. An imaging device comprising:
an imaging section;
a judging section which judges whether or not an image captured by the imaging section satisfies a predetermined composition condition; and
a control section which controls an imaging composition of the imaging section so that the captured image satisfies the predetermined composition condition based on the judging result of the judging section.

2. The imaging device according to claim 1, wherein the predetermined composition condition is that a sky image and a ground image are present at a predetermined ratio in the captured image.

3. The imaging device according to claim 1, further comprising:
a driving section which changes a capturing direction of the imaging section,
wherein the control section changes the imaging composition of the imaging section by controlling the driving section to change the capturing direction of the imaging section.

4. The imaging device according to claim 1,
wherein the imaging section includes a trimming section which trims the captured image, and
wherein the control section changes the imaging composition of the imaging section by changing a trimming range of the trimming section.

5. The imaging device according to claim 1, wherein the judging section judges whether or not the captured image satisfies the predetermined composition condition based on a luminance distribution of the captured image.

6. The imaging device according to claim 1, wherein the imaging section is mounted on a user's head.

7. An imaging control method comprising;
a step of judging whether or not an image captured by an imaging section satisfies a predetermined composition condition; and
a step of changing an imaging composition of the imaging section so that the captured image satisfies the predetermined composition condition based on the judging result.

8. A non-transitory computer-readable storage medium having stored thereon a program that is executable by a computer, the program being executable by the computer to perform functions comprising:
judging processing for judging whether or not an image captured by an imaging section satisfies a predetermined composition condition; and
controlling processing for changing an imaging composition of the imaging section so that the captured image satisfies the predetermined composition condition based on the judging result.
